(19) United States
(12) Patent Application Publication
(10) Pub. No.: US 2013/0054644 A1
(43) Pub. Date: Feb. 28, 2013

(54) INFORMATION PROCESSING METHOD AND PROGRAM FOR REGISTERING SPECIAL DAY AND INFORMATION PROCESSING APPARATUS

(71) Applicant: Mayu Nakano, Kyoto (JP)

(72) Inventor: Mayu Nakano, Kyoto (JP)

(73) Assignee: OMRON CORPORATION, KYOTO (JP)

(21) Appl. No.: 13/578,288

(22) PCT Filed: Jan. 19, 2011
(86) PCT No.: PCT/JP2011/050846

§ 371 Date: Oct. 24, 2012

(30) Foreign Application Priority Data
May 28, 2010 (JP) 2010-122748

(51) Int. Cl. G06F 17/30

(52) U.S. Cl. 707/774; 707/E17.014

(57) ABSTRACT

An information processing apparatus has a storage section in which an expression pattern table and a special day data table are registered, a plurality of expression patterns being stored in the expression pattern table, the expression pattern expressing a periodical special day using a first character variable expressing a name of the special day and a second character variable expressing a day, a plurality of generic names of the special day being stored in the special day data table, a communication section for transmitting and receiving document data, an analysis section for performing a morpheme analysis and a syntax analysis to the document data transmitted or received by the communication section, and a search section for performing a first search and a second search to the document data based on analysis results of the analysis section.

### TECHNICAL FIELD

The present invention relates to an information processing method that is performed to register information on a periodical special day, such as a birthday and a wedding anniversary, in a memory of a computer, a program to which the method is applied, and an information processing apparatus.

### BACKGROUND ART

In recent years some mobile phones have a function of notifying a user that previously-registered special day is coming soon in several days. For example, Patent Document 1 discloses the function in which a person's special day, such as he or her birthday, can be registered in a telephone directory of the mobile phone, and a notice icon is displayed on a screen for several days prior to the registered special day, and, in response to selection of the icon, the detailed information on the special day is displayed.

As to the registration of schedule information, there has been developed a technology in which registration target information is automatically extracted by analyzing document data, such as an electronic mail. For example, Patent Document 2 discloses that an itemization portion is extracted from the electronic mail, and schedule information is further extracted from the itemization portion for each of items, such as a title, date and time, and a place.

### CITATION LIST

### Patent Document

Patent Document 1: Japanese Unexamined Patent Publication No. 2007-281738
Patent Document 2: Japanese Unexamined Patent Publication No. 2009-93503

### SUMMARY

As disclosed in Patent Document 1, it may be necessary for the user to previously register contents or the date of the special day in order to perform previous notification of the special day. There is a demand to perform automatic registration based on a analysis result of the document data, such as the electronic mail, because the registration work becomes significantly troublesome. However, in conventional information processing, as disclosed in Patent Document 2, only the information extracted from the document data may be registered, but information is not registered in consideration of periodicity of the special day.

Further, when users conduct communication with each other about the periodical special day, because a document of an ambiguous expression is frequently produced, the day of the special day may not be able to be correctly be decided. Even if the whole document data is analyzed to extract a character string expressing the name or the day of the special day, the character string is not necessarily used in the same conversation subject.

One or more embodiments of the present invention recognizes the name and the date of the periodical special day with high accuracy to register high-reliability information using the analysis result of the document data in which the conversation subject relating to the periodical special day is described.

In an information processing method according to one or more embodiments of the present invention, an expression pattern table and a special day data table are previously registered in a memory of a computer including a function of transmitting and receiving document data, a plurality of expression patterns being stored in the expression pattern table, the plurality of expression patterns expressing the periodical special day using a first character variable expressing a name of the special day and a second character variable expressing a day, a plurality of generic names of the special day being stored in the special day data table.

According to one or more embodiments of the present invention, a plurality of kinds of expression patterns commonly used in various special days are stored in the expression pattern table. Almost all the generic names stored in the special day data table have an annual period (such as “birthday” and “wedding anniversary”) and a monthly period (such as “payday” and “executive board”). A name of a special day having a period of several months or a special day in which the period cannot uniquely be specified may be stored.

In the information processing method according to one or more embodiments of the present invention, the computer in which each table is registered performs the following first to fifth steps.

In the first step, a morpheme analysis and a syntax analysis are performed to the document data transmitted or received by the computer. In the second step, a first search and a second search are performed to the document data based on analysis results of the first step. The first search extracts a character string including the generic name stored in the special day data table and a phrase modifying the generic name. The second search extracts a character string expressing the day.

In the third step, matching is performed to a range including the character strings extracted from the document data by the first and second searches using the expression pattern table in which the character string extracted by the first search is applied to the first character variable while the character string extracted by the second search is applied to the second character variable.

The third step transitions to the fourth step when an expression applied to one of the expression patterns is extracted from the document data, and a date of the special day is estimated based on concepts of the character strings applied to the first and second character variables. For example, the specific date is derived from the character string applied to the second character variable, and further the date data can be derived by applying the period to the specific date according to the concept of the character string applied to the first character variable such that the date data expressed as Month Day when the period is annual and such that the date data expressed as Day when the period is monthly.

In the fifth step, the character string applied to the first character variable is set to the name of the special day, and a combination of the name of the special day and the date estimated in the fourth step is registered in the memory of the computer.

A length of the character string modifying the generic name of the special day varies depending on a situation. In one or more embodiments of the present invention, the character string including the generic name and the phrase modifying the generic name are extracted from the document data including the generic name of the special day by the first search, and the matching of the relationship between the whole character string and the character string expressing the day is performed to each expression pattern, so that the expression expressing the special day can be extracted with high accuracy. Further, the information indicating the name or the date of the special day can be registered based on the extracted expression.

In a method according to one or more embodiments of the present invention, when a character string indicating the number of days relative to a present time is extracted as the character string expressing the day by the second search, in the third step, the date corresponding to the second variable is estimated by applying the number of days relative to the present time, which is indicated by the character string, to a transmission date or a receipt date of the processing target document data.

For the exchange of the document data that expresses the day by the relative expression, such as “yesterday” and “tomorrow”, it is reasonable that the day is expressed based on the transmission date or the receipt date. According to the above embodiments, estimation accuracy of the date of the special day can be ensured even if the day of the special day is ambiguously expressed.

In a method according to one or more embodiments of the present invention, the special day data table includes data in which the generic name of the special day and a replacing generic name are combined. Additionally, in the fifth step when a character string including the generic name combined with the replacing generic name is extracted by the first search, the generic name in the character string applied to the first character variable is changed to the replacing generic name, and the post-change character string is combined as the name of the special day with the date estimated in the fourth step.

According to the above embodiments, in registering the information extracted from the document data referring to the day on which a special event is initially generated, even if the name of the special day after the second time differs from that of the first time, the proper name can be registered as the special day after the second time.

For example, “wedding anniversary” is combined as a replacing name with “wedding ceremony”, and the combination is stored in the special day data table. Then, when the character string of “wedding ceremony of Mr./Ms. A” is extracted from the processing target document, this character string can be registered as replaced with the character string of “wedding anniversary of Mr./Ms. A”.

In an information processing method according to one or more embodiments of the present invention, an expression pattern indicating an expression that negates the special day and an expression pattern indicating an expression that affirms the special day are stored in the expression pattern table. Additionally, the fourth step and the fifth step are not performed when an expression applied to the expression pattern indicating the expression that negates the special day is found in the third step.

According to the above embodiments, when the character string expressing the name of the special day or the character string expressing the day are used in the expression that negates the special day although included, the registration of the false information caused by the character strings can be prevented. Therefore, the reliability of the registration information can be enhanced.

A program to which the method is applied is incorporated in a computer including communication means for transmitting and receiving document data, the program causes the computer to act as: storage means in which the expression pattern table and the special day data table are registered; analysis means for performing a morpheme analysis and a syntax analysis to the document data transmitted or received by the communication means; search means for performing a first search and a second search to the document data based on analysis results of the analysis means; expression matching means for performing matching to a range including the character strings extracted from the document data by the first and second searches using the expression pattern table in which the character string extracted by the first search is applied to the first character variable while the character string extracted by the second search is applied to the second character variable; date estimation means for estimating a date of the special day based on concepts of the character strings applied to the first and second character variables, when an expression applied to one of the expression patterns is extracted from the document data through the processing of the expression matching means; and registration processing means for setting the character string applied to the first character variable to the name of the special day, and registering a combination of the name and the date estimated by the date estimation means in a memory of the computer.

For example, the program is installed in a computer that operates as a controller of a mobile terminal or a personal computer. The computer in which the program is installed operates as an information processing apparatus including the storage means, the communication means, the analysis means, the search means, the expression matching means, the date estimation means, and the registration processing means.

According to one or more embodiments of the invention, in the computer that transmits and receives the document data including the description relating to the special day, the morpheme analysis and the syntax analysis are performed to the document data, and the character string expressing the name of the special day and the date can be recognized with high accuracy and registered based on the analysis result. Thereby, the user is released from the trouble of registering the special day, and the user can easily use special day informing service and schedule management.

### BRIEF DESCRIPTION OF THE DRAWINGS

FIG. 1 is a functional block diagram illustrating a configuration of an application for processing information on special days.

FIG. 2 is a view illustrating a data configuration example of a special day data table.

FIG. 3 is a view illustrating a data configuration example of a date data table.

FIG. 4 is a view illustrating a data configuration example of an expression pattern table and an application example for each expression pattern of the expression pattern table.

FIG. 5 is a flowchart illustrating a matching processing sequence in which the expression pattern table is used.

FIG. 6 is a view illustrating a data configuration example of a recognition result retaining table.

FIG. 7 is a view illustrating a data configuration example of a processing result data table.

FIG. 8 is a view illustrating a specific example of processing performed to document data and a notification example in which registered information is used.

FIG. 9 is a view illustrating an example in which a name of the special day extracted from document data is replaced with another name and the replaced name is registered.

FIG. 10 is a view illustrating an example in which a date data range is narrowed based on processing performed to the plurality of pieces of document data.

FIG. 11 is a flowchart illustrating a sequence of processing of registering the information relating the special day.

FIG. 12 is a view illustrating a specific example of processing performed to a posting article to a blog and an output data retaining table in which information processed through the processing is registered.

### DETAILED DESCRIPTION

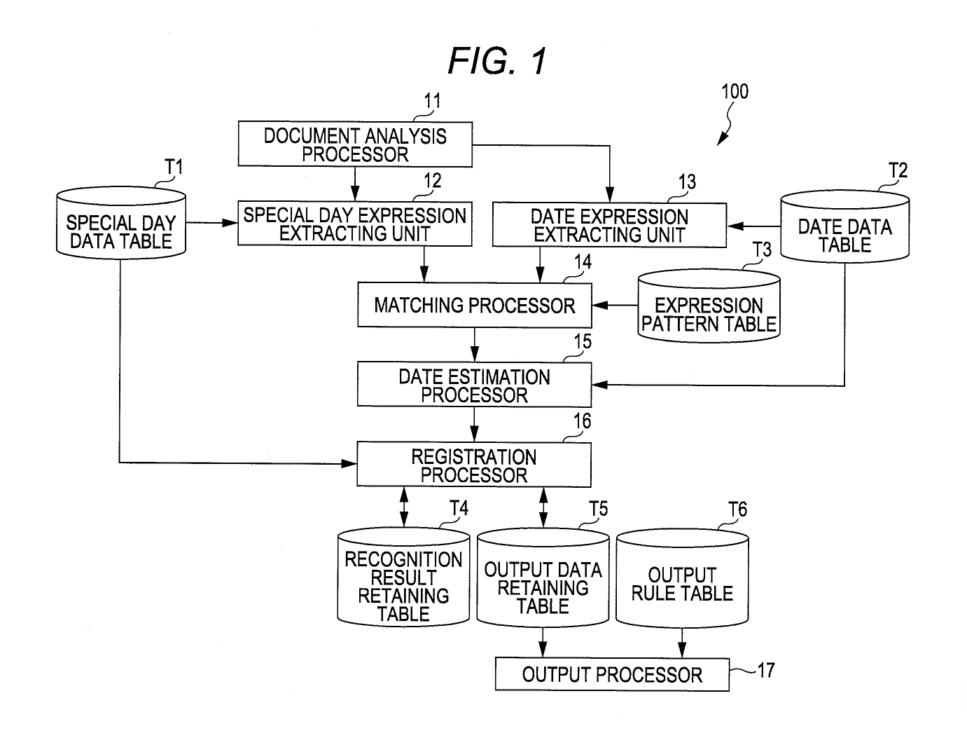

Embodiments of the present invention will be described below with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. FIG. 1 is a functional block diagram illustrating an application for processing information on special days. An application 100 is incorporated in a controller of a mobile phone. In response to transmission or receipt of an electronic mail by an electronic mail application (not illustrated), the application 100 extracts an expression relating to special days from document data of the electronic mail, and registers information on the special day based on an extraction result. The application 100 also includes a function of notifying a user that the registered special day comes closer and a function of outputting registration information of the special days to an external application (such as a scheduler and a telephone directory).

Specifically, the application 100 includes processors of a document analysis processor 11, a special day expression extracting unit 12, a date expression extracting unit 13, a matching processor 14, a date estimation processor 15, a registration processor 16, and an output processor 17 and data tables, such as a special day data table T1, a date data table T2, an expression pattern table T3, a recognition result retaining table T4, an output data retaining table T5, and an output rule table T6. In the six kinds of the data tables T1 to T6, pieces of data necessary to recognize the expression relating to the special days are stored in the tables T1, T2, and T3, and pieces of information derived as a recognition result are stored in the tables T4 and T5. A definition and setting data, which are necessary for notification or output of the special day, are stored in the table T6.

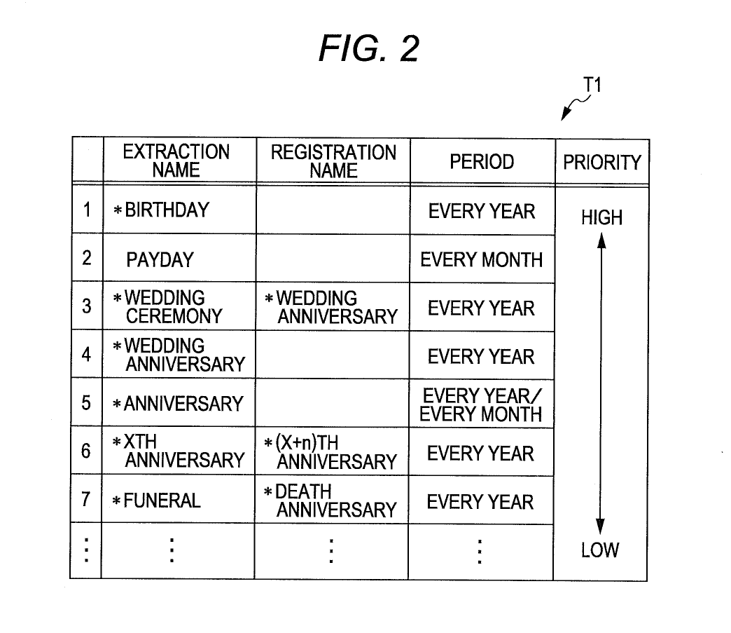

Here, the tables T1, T2, and T3 will be described with reference to FIGS. 2 to 4. Note that, for the sake of convenience, in FIGS. 2 to 4, an identification number (1, 2, 3, . . . ) is provided for each piece of information for one record.

FIG. 2 illustrates a configuration example of the special day data table T1. The information for one record of the table T1 includes an extraction name, a registration name, a period, and a priority.

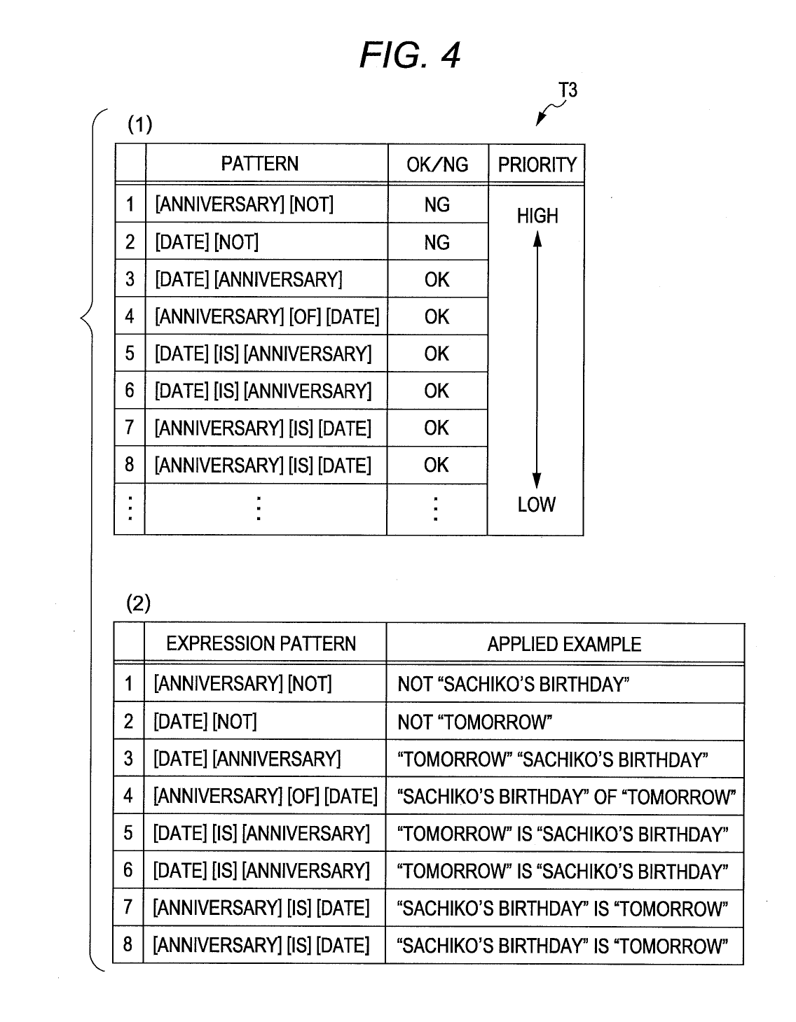

Note that, although a specific numerical value is actually set to the priority among the records, the numerical value is omitted by arraying the special days in the descending order of the priority in FIG. 2. The same holds true for the expression pattern table T3 in FIG. 4(1).

“Extraction name” is a name of the special day extracted from document data. In the example in FIG. 2, a plurality of words (generic names of the special days), such as “birthday”, “payday”, and “wedding ceremony”, which are frequently used as the name of the special day, are registered. A symbol (* or X) is added to each word except “payday”, and the symbol expresses a character string modifying each word. X means an arbitrary numerical character, and means an arbitrary character string except the numerical character. For example, of the character string of “Sachiko's birthday”, “Sachiko's” corresponds to a portion of the first extraction name. “Anniversary” of the character string of “10th anniversary” corresponds to the portion of * of the sixth extraction name, and “10th” corresponds to a portion of X of the extraction name.

The special day expressed by the extraction name includes a special day on which the name of the next corresponding day may be changed. A registration name indicates the post-change name, and the registration name is set only when it is necessary to change the name. Like the extraction name, the character string of the modifying portion is also set to the registration name using the same symbol * or X. The character string of the portion of * or X, which is set to the extraction name, is directly maintained.

For example, in the third record in FIG. 2, the registration name of “* wedding anniversary” is set to the extraction name of “* wedding ceremony”. In the sixth record, the registration name of “* (X+n)th anniversary” (n is the number of years elapsed since the year when the special day was registered) is set to the extraction name of “* Xth anniversary”. In the seventh record, the registration name of “* death anniversary” is set to the extraction name of “* funeral”. Generally the death anniversary is not matched with the day of the funeral. However, because the date close to the actual death anniversary can automatically be registered in this way, the registered date only have to be changed to the correct date, and work is largely reduced compared with the case that all the pieces of information are manually input.

The period is annually or monthly set to each of the records of the special days according to each of concepts thereof. Sometimes both annual and monthly periods are set like the fifth record in FIG. 2.

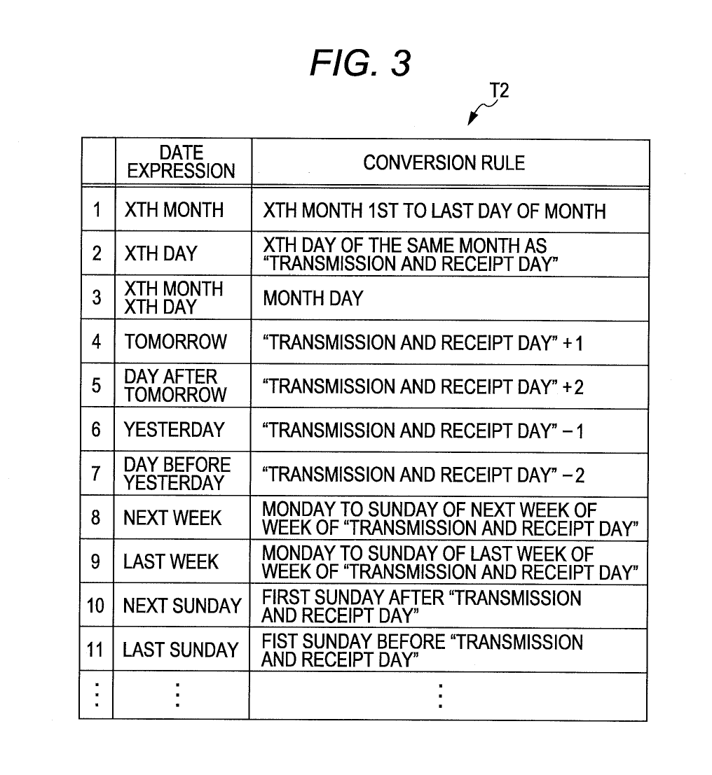

FIG. 3 illustrates a configuration example of the date data table T2. The information for one record of the table T2 includes a date expression and a conversion rule. Examples of the date expressions include a date expression that specifically expresses the month or the day (first to third date expressions in FIG. 3), a date expression that expresses the number of days relative to a present time (fourth to ninth date expressions in FIG. 3), and a date expression that expresses the date by combining a plurality of words (tenth and eleventh date expressions in FIG. 3). In the date expression that specifically expresses the month or the day, like the special day data table T1 in FIG. 2, the numerical value portion is replaced with X (arbitrary numerical value enters X).

The conversion rule derives the specific date from the date expression, and is used by the date estimation processor 15 in FIG. 1. A transmission date or a receipt date (the transmission date and the receipt date are unified to a variable of [transmission and receipt date]) of the electronic mail is used in many conversion rules. For example, an arithmetic expression in which an adjusted value is added to [transmission and receipt date] based on a concept of each expression is set as the conversion rule in the fourth to seventh date expressions (“tomorrow”, “day after tomorrow”, “yesterday”, and “day before yesterday”) in FIG. 3. The conversion rule is set to the eighth and ninth date expressions (“next week” and “last week”) in FIG. 3 based on a concept of each expression in order to derive the dates of one week before or after the week to which [transmission and receipt date] belongs.

FIG. 4(1) illustrates a configuration example of the expression pattern table T3. The information for one record of the table T3 includes an expression pattern, an OK or NG flag, and the priority.

In the expression pattern, the character string expressing the name of the special day is used as a variable [anniversary], and the character string expressing the day of the special day is used as a variable [date]. The expression pattern expresses a standard expression relating to the special day.

The OK flag indicates that the corresponding expression pattern is the expression affirming the special day, and the NG flag indicates that the corresponding expression pattern is the expression negating the special day. In one or more embodiments of the present invention, a higher priority is given to the expression pattern to which the NG flag is set compared with the expression pattern to which the OK flag is set. Note that, although only two kinds of negative expression patterns are indicated in the example in FIG. 4(1), more negative expression patterns can also be set.

FIG. 4(2) indicates a correlation between each expression pattern and an example of the specific expression to which the expression pattern is to be applied. In each example, the character string of “Sachiko's birthday” is applied to the variable [anniversary], and the character string of “tomorrow” is applied to the variable [date].

Note that, in the expression patterns in FIG. 4, the character strings except [anniversary] and [date] are specifically indicated, but it is not limited to this, and for example, an expression pattern in which an arbitrary character string is located between variables (however, a numerical range of a character string length of the character string is restricted) may be set.

Referring back to FIG. 1, functions of the processors 11 to 17 will be described. The document analysis processor 11 performs a morpheme analysis to the document data of the transmitted mail or the received mail, to thereby recognize each word in a body text while cutting the body text into words. The document analysis processor 11 performs a syntax analysis based on a result of the morpheme analysis, to thereby produce tree structure data representing a relationship among words. The tree structure data is used by the special day expression extracting unit 12, the date expression extracting unit 13, and the matching processor 14.

The special day expression extracting unit 12 focuses attention on each extraction name of the special day data table T1 in FIG. 2 in the descending order of the priority, and searches the document data based on the analysis result of the document analysis processor 11 using the focused extraction name. The character string including the generic name of the focused extraction name and the phrase (portion corresponding to * or X) modifying the generic name is extracted in the search. Note that only the generic name is extracted when the modification portion is not found. When the character string applied to one of the extraction names is found, the special day expression extracting unit 12 sets the character string to [anniversary].

In one or more embodiments of the present invention, like the fourth and fifth extraction names in FIG. 2, a higher priority is given to the longer character length of the generic name among the plurality of extraction names having the generic names including the same character string. Accordingly, the extraction names are called in the descending order of the priority to perform the search, which allows prevention of confusion of the extraction name such that the character string corresponding to “* wedding anniversary” is mistakenly regarded as the character string corresponding to “* anniversary”.

It is to be noted that, according to one or more embodiments of the present invention, in order to clarify the property of the phrase modifying the generic name of the special day, the extraction name or the registration name in the special day data table T1 is expressed in the form in which the generic name is modified by the symbol * or X. However, it is not limited to this, and the simple generic name may be set to the extraction name or the registration name. However, even in such cases, it is necessary for the special day expression extracting unit 12 to extract the character string including the generic name and the phrase modifying the generic name, and to set the extracted character string in its entirety to the character variable [anniversary].

The date expression extracting unit 13 focuses attention on each date expression of the date data table T2 in FIG. 3, and searches the document data using the focused date expression. When the character string applied to one of the date expressions is found through the search, the date expression extracting unit 13 sets the character string to the variable [date]. Note that the priority is also given to each record in the date data table T2 based on the same rule as the special day data table T1, and the record having the highest priority is selected when the character string applied to the plurality of date expressions through the search. For example, the first to third date expressions in the date data table T2 are applied to the character string of “March 10th”, and a determination that the character string of “March 10th” hits the third date expression is made.

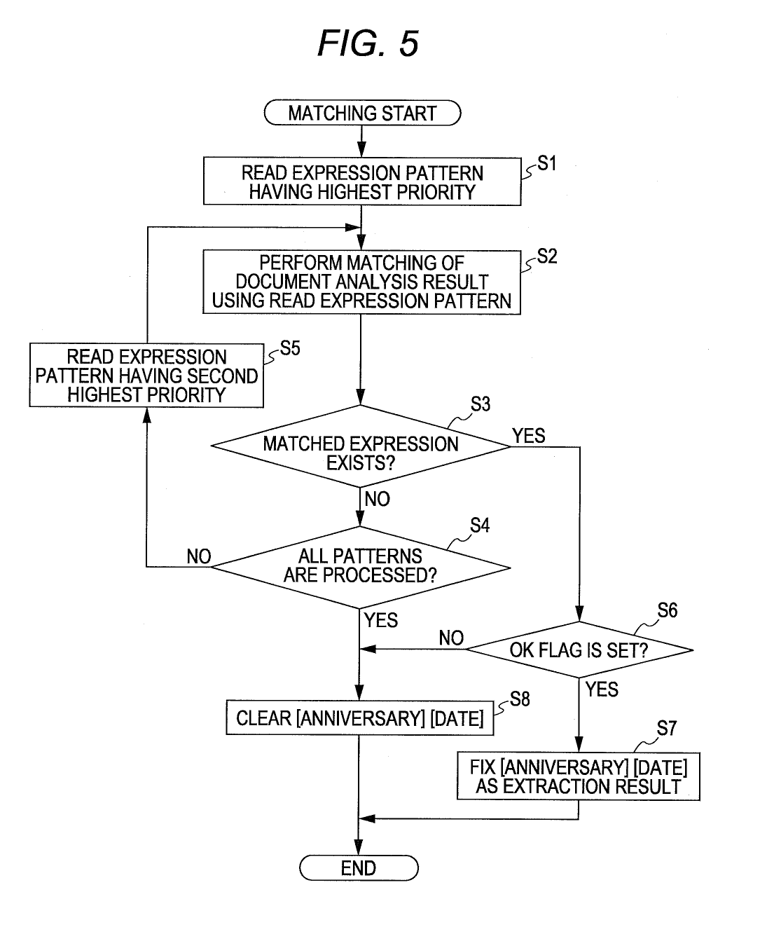

The matching processor 14 starts processing in FIG. 5 in response to the settings of the specific character strings to [anniversary] and [date]. As a description will be made with reference to FIG. 5, the matching processor 14 first reads the expression pattern having the highest priority from the expression pattern table T3 (Step S1). Then the matching of the tree structure data produced by the document analysis processor 11 is performed using the expression pattern to determines whether the expression matched with the read pattern in the range including the character string corresponding to each variable exists (Steps S2 and S3). The expression patterns are thereafter read in the descending order of the priority until the matched expression is found (Steps S3 to S5), and the matching processing is performed using the read pattern (Step S2).

As a result, when the expression matched with one of the expression patterns is found (YES in Step S3), a flag set to the expression pattern is checked. When the OK flag is set (YES in Step S6), the character strings set to [anniversary] and [date] are fixed as an extraction result (Step S7).

On the other hand, when the NG flag is set to the matched expression pattern (NO in Step S6), or when the expression matched with any expression pattern is not found (YES in Step S4), each character variable is cleared (Step S8), and the processing is ended. When the clear processing is performed, the date estimation processor 15 and the registration processor 16 do not operate, and the processing performed to the document data is ended.

As illustrated in FIG. 4(1), in the expression pattern table T3 according to one or more embodiments of the present invention, while the expression pattern in which one of the two kinds of character variables [anniversary] and [date] is used is set as the expression that negates the special day, the expression pattern in which the both character variables [anniversary] and [date] are used is set as the expression that affirms the special day, and the processing in FIG. 5 is performed. The higher priority is given to the negative expression pattern compared with the affirmative expression pattern. Therefore, the production and registration of the false information caused by the expression that negates the special day can be prevented.

For example, both the expression that “tomorrow” is not “Sachiko's birthday” and the expression that “tomorrow” is “Sachiko's birthday” are matched with the sixth expression pattern. However, because the expression of the former is also matched with the first expression pattern, “tomorrow” and “Sachiko's birthday”, which are extracted from the expression that “tomorrow” is not “Sachiko's birthday”, are cleared in Step S8. Therefore, the false information is not registered. On the other hand, the expression of the latter is not matched with the expression pattern to which the NG flag is set, so that “tomorrow” and “Sachiko's birthday” can be fixed as the extraction result when the expression that ““tomorrow” is “Sachiko's birthday”” is matched with the sixth expression pattern.

However, it is not always necessary to set the priority to the expression pattern table T3. In the case where the priority is not set to the expression pattern table T3, the matching of the document data may be performed to all the expression patterns. Such a processing also allows the prevention of the registration of the false information caused by the expression that negates the special day, in the case where [anniversary] and [date] are cleared as the expression matched with the expression pattern to which the NG flag is set is found.

Referring back to FIG. 1 again, the description will be made. When [anniversary] and [date] are fixed through the processing of the matching processor 14, the date estimation processor 15 performs estimation processing. The date estimation processor 15 performs the matching of the date data table T2 using the character string applied to [date], reads the conversion rule corresponding to the character string, and derives the date data indicating the specific date based on the conversion rule. The derived date data is combined with [anniversary] instead of the character string of [date]. Note that a calendar information database (not illustrated) is also used in the date data deriving processing.

The registration processor 16 searches each extraction name of the special day data table T1 using [anniversary]. When the record corresponding to [anniversary] is found through the search, the registration processor 16 changes the date data to the format suitable for the period included in the extracted record. For example, the date data is set to Month Xth day for the annual period, and the date data is set to Xth day for the monthly period.

The registration processor 16 produces the recognition result data by a combination of [anniversary], the period extracted through the search, and the date data. When it is found through the search that the registration name corresponds to [anniversary], [anniversary] of the recognition result data is replaced with the registration name. Contents of the recognition result retaining table T4 and the output data retaining table T5 are updated by the fixed recognition result.

The output processor 17 performs the special day notifying processing and output to another application that are described above, based on the data registered in the output data retaining table T5. Setting information necessary for the notification and the output is stored in the output rule table T6. For example, as to the notification, notification timing, a template of a message used for the notification, and image information displayed together with the message, etc. are registered for each kind of the special day name. As to the pieces of information, information input from the user can also be registered in addition to default information.

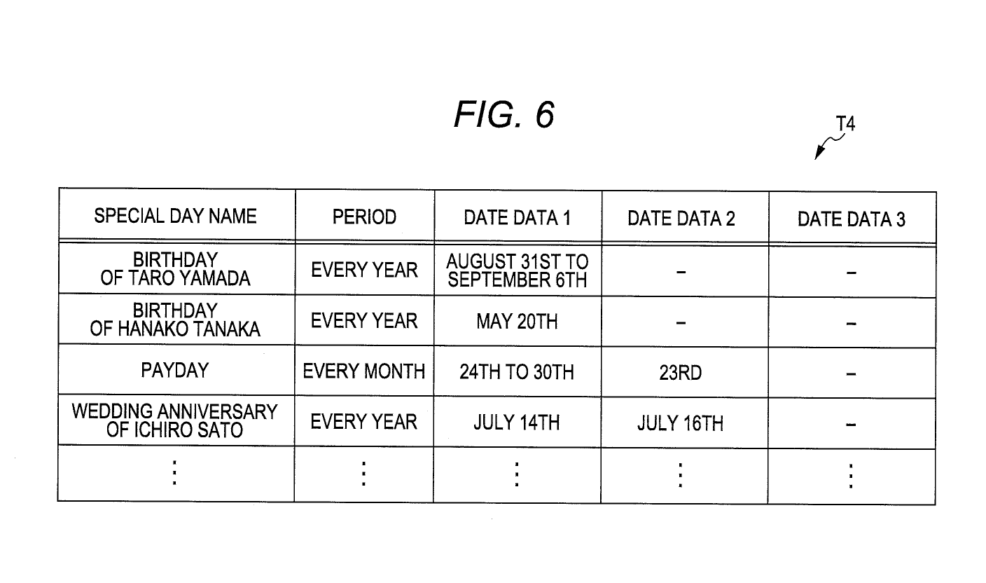

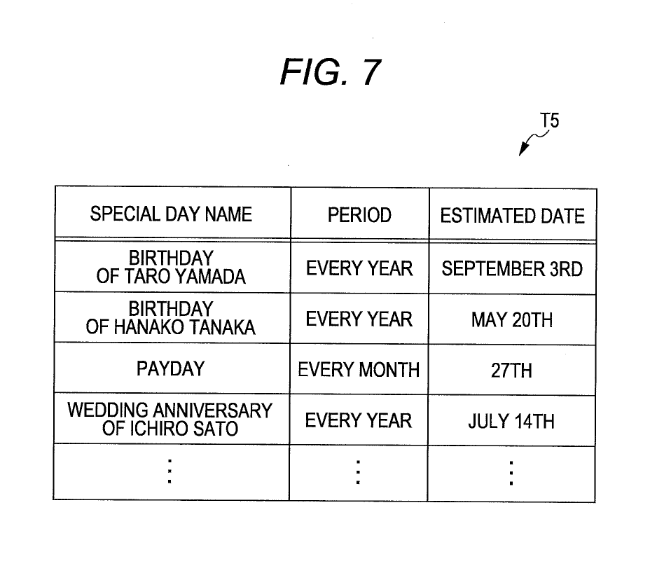

FIG. 6 illustrates a configuration example of the recognition result retaining table T4, and FIG. 7 illustrates a configuration example of the output data retaining table T5. The name (by the variable [anniversary]) and the period of the recognized special day are stored in each of the tables T4 and T5. While, as to the date, the date data obtained through the processing of the date estimation processor 15 is directly stored in the recognition result retaining table T4 in FIG. 6, one specific day is stored as the estimated date in the output data retaining table T5 in FIG. 7.

The recognition result retaining table T4 is set to be able to store the plurality of pieces of date data in each record according to a possibility that the plurality of pieces of document data are processed with respect to the same special day. Although not illustrated in FIG. 6, a numerical value indicating the priority is set to each piece of date data, and the estimated date of the output data retaining table T5 is decided based on the priority of the date data. For example, two pieces of date data of “July 14th” and “July 16th” are registered with respect to “wedding anniversary of Ichiro Sato” in the recognition result retaining table T4 in FIG. 6, and “July 14th” is adopted in the output data retaining table T5 in FIG. 7. This is because, in the recognition result retaining table T4, the higher priority is given to “July 14th” compared with “July 16th”. The date data registration processing will be described in detail later.

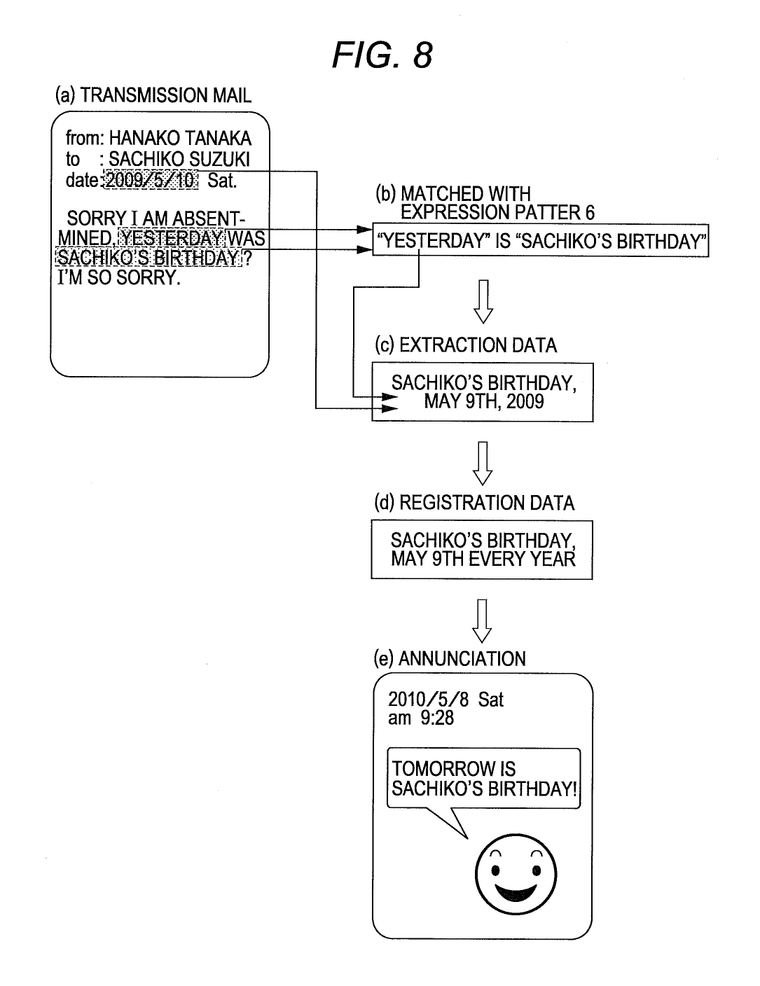

FIG. 8 illustrates a specific example of information processing performed to a mail document transmitted by the user and an output example of post-registration information in the mobile phone to which the application 100 is introduced. As illustrated in FIG. 8(a), the mail document of the present example includes the character string of “Sachiko's birthday” indicating the content of the special day and the character string of “yesterday” indicating the day of the special day. “Sachiko's birthday” is extracted as the character string matched with the first extraction name “* birthday” in the special day data table T1 in FIG. 2, and “yesterday” is extracted as the character string matched with the sixth data in the date table T2 in FIG. 3.

The character strings are applied to the variable [anniversary] and the variable [date], respectively, and the matching processing in FIG. 5 is performed. Consequently, as illustrated in FIG. 8(b), the expression matched with the sixth expression pattern exists in the document data, the specific date (May 9, 2009) of the special day is derived based on the conversion rule correlated with “yesterday” and the transmission date (May 10, 2009) of the mail document. Therefore, the data having the content in FIG. 8(c) is fixed as the data extracted from the transmitted mail.

Through the search processing performed to the special day data table T1, the period corresponding to “Sachiko's birthday” is read to change the date data. Therefore, the data having the content in FIG. 8(d) is fixed as the recognition result, and registered in the recognition result retaining table T4.

FIG. 8(e) illustrates an example of a notification screen that is displayed on the day before the registration day in the next year after the registration. In the example in FIG. 8(e), the message indicating the content (Sachiko's birthday) of the registered special day and the day (tomorrow) of the special day is displayed together with a character image based on the information registered in the output rule table T6.

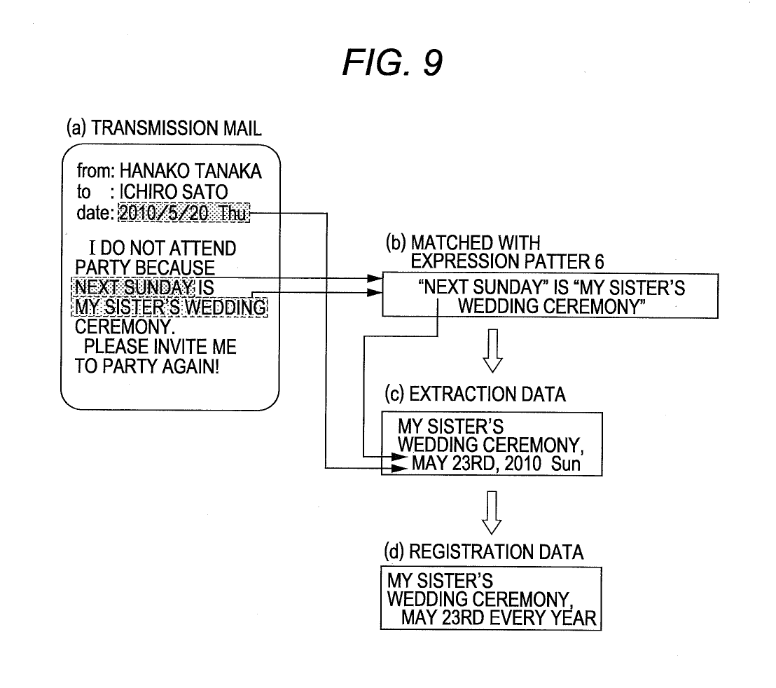

FIG. 9 illustrates an example in which replacing processing is performed with use of the registration name in the special day recognizing processing. In the example in FIG. 9(a), the transmitted mail includes the character string of “next Sunday is my sister's wedding ceremony”. Therefore, “my sister's wedding ceremony” and “next Sunday” are extracted as the character strings corresponding to the variables [anniversary] and [date], respectively. As a result of the matching processing of the matching processor 14, as illustrated in FIG. 9(b), it is found that the sixth expression pattern is included in the document data. Further, the extraction data having the content in FIG. 9(c) is fixed based on the conversion rule corresponding to “next Sunday” and the transmission date of the mail document.

The special day data table T1 is searched using “may sister's wedding ceremony” to read the corresponding record. Referring to FIG. 2, the read record includes the registration name (* wedding anniversary). Accordingly, based on the registration name, “may sister's wedding ceremony” is replaced with “my sister's wedding anniversary”, the period data is added, and the date data is changed, and therefore, the recognition result having the content in FIG. 9(d) is fixed and registered in the recognition result retaining table T4.

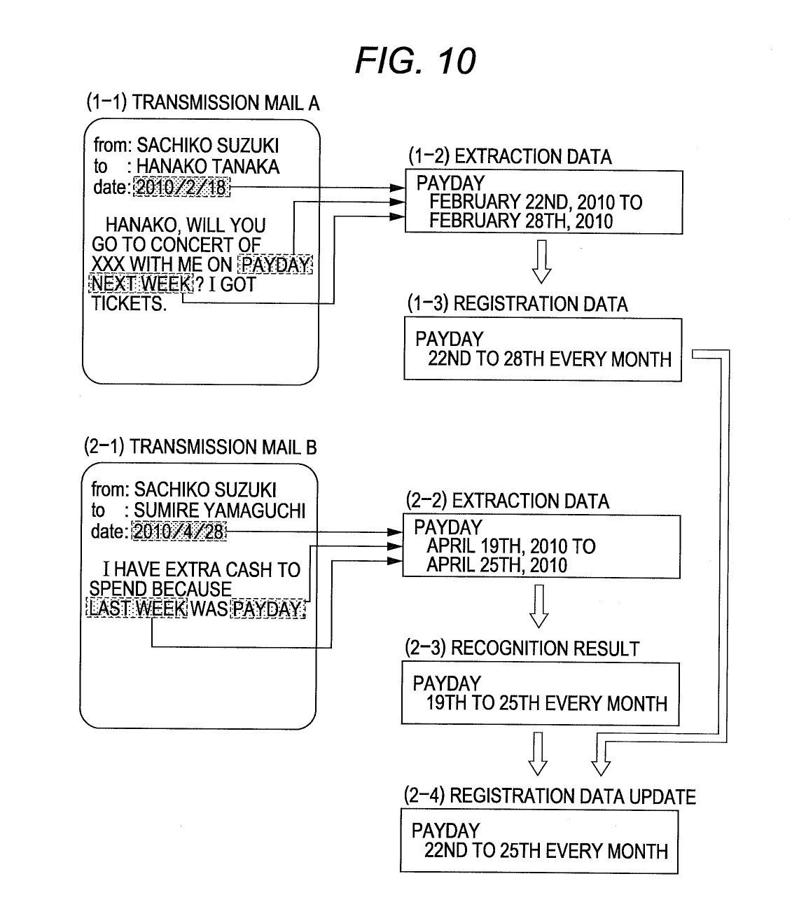

Subsequently, FIG. 10 illustrates an example in which, using the event in which the date of the special day is recognized with a range having a certain width, the range of the date is narrowed based on the recognition results of the plurality of mail documents relating to the same special day.

As illustrated in FIGS. 10(1-1) and 10(2-1), a mail A includes the expression of “payday next week”, and a mail B includes the expression of “last week payday”. Although not illustrated in FIG. 10, the expression of the mail A is matched with the fourth expression pattern in the expression pattern table T3, and the expression of the mail B is matched with the third expression pattern.

In the processing performed to the transmitted mail A, the dates from Monday to Sunday of next week of the transmission date (Feb. 18, 2010) of the mail document are derived based on the conversion rule corresponding to “next week” in the date data table T2 (FIG. 10(1-2)). Additionally, frequency data corresponding to “payday” is applied to the range of the date, whereby the data of “22nd to 28th every month” is fixed as the recognition result and registered in the recognition result retaining table T4 (FIG. 10(1-3)).

In the processing performed to the transmitted mail B, the dates from Monday to Sunday of last week of the transmission date (Apr. 28, 2010) of the mail document are derived based on the conversion rule corresponding to “last week” in the date data table T2 (FIG. 10(1-2)). Additionally, the frequency data corresponding to “payday” is applied to the range of the date, whereby the data of “19th to 25th every month” is fixed as the recognition result (FIG. 10(2-3)).

Furthermore, in the event in FIG. 10, because the data in FIG. 10(1-3) is already registered with respect to “payday”, the matching processing of the date data range of the recognition result is performed to the registered range to extract an overlapping range (22nd to 25th). As illustrated in FIG. 10(2-4), the date data range registered in the recognition result retaining table T4 is rewritten to the range extracted through the current processing.

As illustrated the examples in FIGS. 8 to 10, in the application 100 according to one or more embodiments of the present invention, the character string expressing the content of the special day and the character string expressing the day are extracted from the body text data of the mail document, the matching processing of the expression of the range including the character strings is performed to each expression pattern, and each character string is fixed as the character string expressing the special day only when the expression is applied to the expression pattern to which the OK flag is set. In the matching processing in which the expression pattern is used, the whole character string including the name indicating the special day and the phrase modifying the name is applied to the variable [anniversary], so that the matching processing can properly be performed irrespective of the length of the modification portion. Particularly, even if the date expression is placed in front of the expression indicating the name, the corresponding expression pattern can be specified with high accuracy irrespective of the length of the modification portion of the name. Even if the character string applied to the variable [anniversary] or [date] is extracted, in the case where the expression of the character string is applied to the expression pattern to which the NG flag is set, or in the case where the expression of the character string is not applied to any expression pattern, the recognition data relating to the special day is not derived. Therefore, the registration of the improper information can be prevented.

Further, in the case where it is necessary to change the name of the special day extracted from the document data, a function of changing the name and registering the changed name and a function of narrowing or correcting the date data are provided in the application 100. Therefore, the more proper information can be registered.

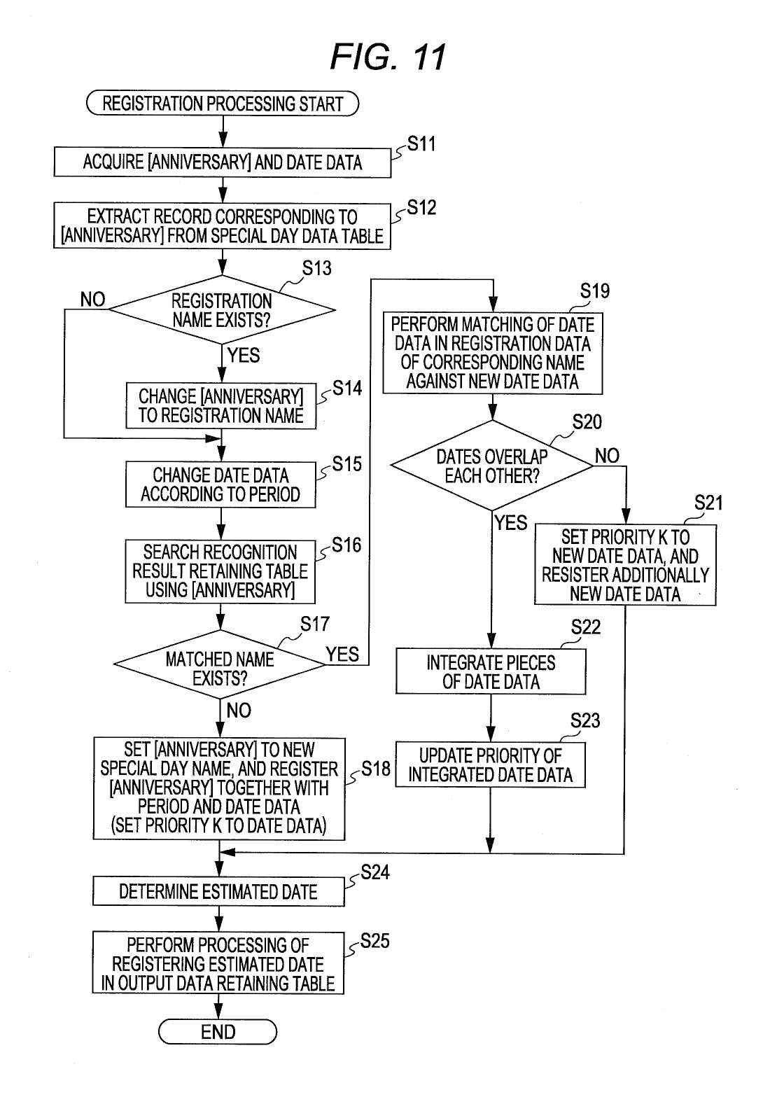

The processing performed by the registration processor 16 will be described below in detail with reference to FIG. 11. Steps S11 to S23 in FIG. 11 illustrates a sequence of the registration processing performed to the recognition result retaining table T4. In the registration processing, firstly [anniversary] fixed as the extraction result and the date data derived by the date estimation processor 15 are acquired (Step S11).

Next, the record corresponding to [anniversary] is extracted by searching the extraction name of the special day data table T1 using [anniversary] (Step S12). When the record includes the registration name (YES in Step S13), [anniversary] is changed to the registration name (Step S14). The date data is also changed to the data having the format corresponding to the period in the extracted record (Step S15). The recognition data is fixed through the pieces of processing in Steps S11 to S15.

Subsequently, in Step S16, the special day name in the recognition result retaining table T4 is searched using [anniversary]. When the special day name matched with [anniversary] is not found through the search (NO in Step S17), [anniversary] is set to the new name of the registration day, and the new record including the name, the period, and the date data is registered in the recognition result retaining table T4 (Step S18). A given numerical value K is set as the priority of the date data to the new record.

On the other hand, when the special day name matched with [anniversary] is found (YES in Step S17), the matching processing of the date data in the registration data of the name is performed to the new date data (set in Step S15) (Step S19). Note that in the case where the registration data includes the plurality of pieces of date data, the matching processing is performed for each piece of the date data.

When the overlapping date is not found among the pieces of date data through the matching processing (NO in Step S20), the new date data is added to the registration data. At this point, the priority K is set to the new date data (Step S21).

On the other hand, when the overlapping date is found among the pieces of date data (YES in Step S20), processing of integrating the pieces of the date data (Step S22) and processing of updating the priority of the integrated date data (Step S23) are performed. For example, as illustrated in the example in FIG. 10, in the case where the pieces of date data in each of which a certain length range is set are integrated, an overlapping portion between the pieces of date data is extracted and the registration data is thereby rewritten in Step S22. A value, in which a predetermined numerical value is added to the priority set before the date data is rewritten, is set as the priority of the post-rewrite date data in Step S23. In the case where the pieces of integrating target date data are identical, the registration data is maintained in Step S22, and the priority adding processing is performed in Step S23.

When the registration processing performed to the recognition result retaining table T4 is completed, the estimated date registered in the output data retaining table T5 is determined based on the registered data (Step S24).

The processing in Step S24 will be described with reference to FIGS. 6 and 7. In the case where the date data expresses the specific one day like the second special day name of “birthday of Hanako Tanaka”, the date is directly determined as the estimated date. In the case where the date data having the setting range is set like the first special day name of “birthday of Taro Yamada”, the date corresponding to the middle day of the range is determined as the estimated date. Furthermore, in the case where the plurality of pieces of date data are set in the recognition result retaining table T4 like the third special day name of “payday” or the fourth special day name of “wedding anniversary of Ichiro Sato”, the estimated date is determined by applying the rule to the date data having the higher priority.

When the estimated date is determined, the registration processing is performed to the output data retaining table T5 (Step S25). Although the detailed sequence of the processing is not illustrated, in the case where the new data is registered in the recognition result retaining table T4 in Step S18, the new registration processing is also performed likewise in Step S25. On the other hand, in the case where only the registration of the date data or the data update is performed in Steps S19 to 23, the output data retaining table T5 is searched using [anniversary] to extract the corresponding registration data, and the estimated date thereof is rewritten by the estimated date determined in Step S24.

In one or more embodiments of the present invention, because the date expression is ambiguous in the case where the date of the special day is estimated by analyzing the expression in the document data, possibly the correct date cannot be specified. In registration processing in FIG. 11, the date data is set to be narrowed or corrected while the plurality of pieces of document data relating to the same special day are processed, so that the estimation accuracy of the date can be enhanced.

Note that, in the case where the character string corresponding to the fifth extraction name (* anniversary) in FIG. 2 is set to [anniversary], it is necessary to consider whether the period is set to a year unit or a month unit, which is omitted in the flowchart in FIG. 11. Specifically, at a stage at which the information including [anniversary] is newly registered, the period data is set to “every year”, and the date data in which the month and the day are specified is set. Then, whether a difference of around 30 days exists between the already-registered date data and the new date data is determined in the date data matching processing (Step S19) when the recognition result of the same name is obtained. When the difference exists, the period is changed to “every month”. According to the change, in Step S24, the estimated date of the corresponding information in the output data retaining table T5 is changed to information (Xth Day) in which the month is not specified.

According to one or more embodiments of the present invention, the character string set to [anniversary] is considered in deriving the date data by the date estimation processor 15. For example, Saturday, Sunday, and a holiday are not included in the date data in the case where “payday” is set to [anniversary], and a day corresponding to tomobiki is not included in the date data in the case where the character string including “funeral” is set to [anniversary].

In the case where the matching processing of the analysis result of the document data is performed to the date data table T2, according to one or more embodiments of the present invention, the character string having the same concept and the character string having the similar concept are also extracted in addition to the character string that is completely matched with the character string registered in the date expression in the date data table T2. For example, using the tenth date expression of “next Sunday” in FIG. 3, “this Sunday”, “coming Sunday”, and “forthcoming Sunday” can be extracted. According to one or more embodiments of the present invention, an algorithm that can derive the correct date is set to the date estimation processor 15 in consideration of a possibility that the date is estimated from the expression (for example, “5th next month”) including at least two pieces of data stored in the date data table T2.

In the above embodiments, the character string set to [anniversary] is directly used as the special day name registered in the recognition result retaining table T4 and the output data retaining table T5. The character string of the modification portion may be changed as needed basis. For example, in the case where the character string in which such a first-person expression as “my birthday” is used as a modifying word is extracted from the document data of the mail, “my” is registered while replaced with the name of the sender of the mail. In the case where a nickname is included in the modification portion, a telephone directory file is searched to extract the name of the person corresponding to the nickname, and the modification portion of [anniversary] may be replaced with the name.

Subsequently, in the above description, the application 100 extracts and registers the expression relating to the special day with the document data of the electronic mail as the processing target. However, the processing target of the application 100 is not limited to the electronic mail. For example, the document data that transmitted to post a blog or a twitter is set to the processing target, and the similar processing can also be performed thereto.

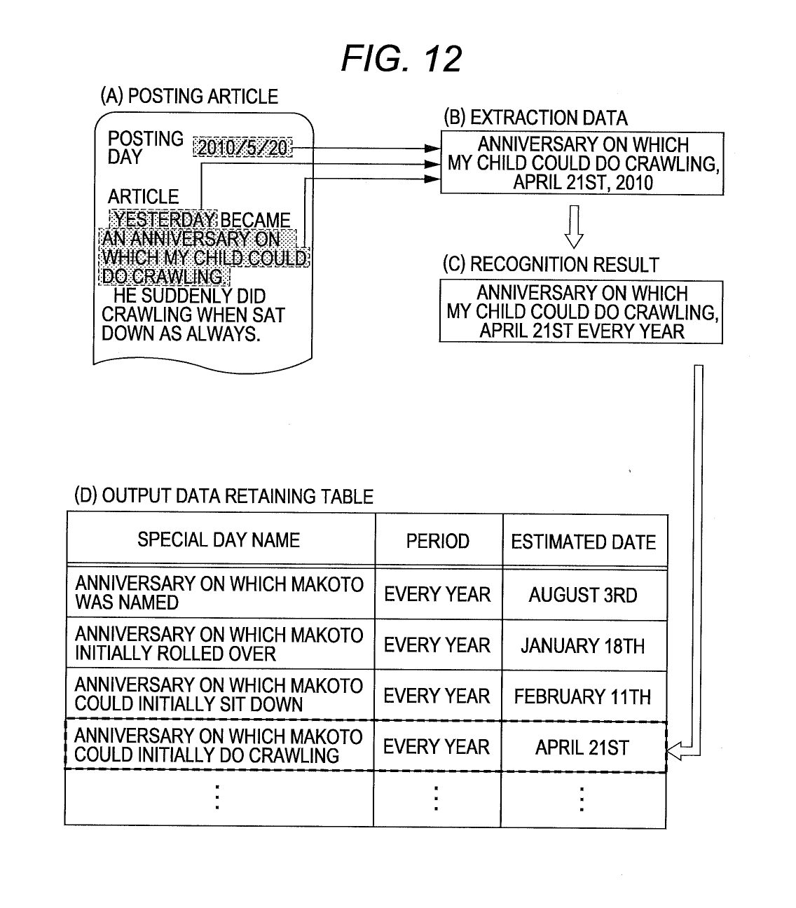

FIG. 12 illustrates an example in which the information relating to the special day is extracted from the document data of the posting article and registered by taking the blog aimed at the child rearing as an example. FIG. 12(A) illustrates part of the document data of the posting article. The document analysis processor 11, the special day expression extracting unit 12, and the date expression extracting unit 13 perform the pieces of processing to the document data, whereby “anniversary on which my child could do crawling” and “yesterday” are set to [anniversary] and [date], respectively. The matching processor 14 performs the matching processing using the character strings. Thereby, it is found that the expression matched with the sixth expression pattern in FIG. 4 is included in the document data, and the character strings set to [anniversary] and [date] are fixed.

Furthermore, according to one or more embodiments of the present invention, the date estimation processor 15 acquires the date (Apr. 22, 2010) of the posting day of the blog, and derives the specific date by applying the conversion rule corresponding to the character string of [date] to the acquired date. As a result the data having the content in FIG. 12(B) is fixed as the extraction data. Additionally, the period corresponding to [anniversary] is read from the special day data table T1 and applied, the recognition result in FIG. 12(C) is obtained.

FIG. 12(D) illustrates an example of the data registered in the output data retaining table T5. In the example in FIG. 12(D), in addition to the registration information based on the recognition result in FIG. 12 (C), the information relating to the special day extracted through the processing performed to the article posted before that is also registered.

According to the application 100, the information expressing the special day can be extracted with high accuracy from the transmitted or received document data and registered. Therefore, not only the user is notified of the day close to the special day, but also the registration information can be reflected in the data of the schedule information or the telephone directory. The specific date of the special day can be obtained from the document data including only the special day name using the registration information in the recognition result retaining table T4 or the output data retaining table T5.

As illustrated in the example in FIG. 12, according to the application 100, the anniversaries having various names freely expressed by the users can be accumulated without performing special registration work, and retained as memories for the future.

As described above, the pieces of information registered for various purposes can be used by enhancing the accuracy of the registered information relating to the special day, and the usability can be improved.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF SYMBOLS

100 Application
T1 Special day data table
T2 Date data table
T3 Expression pattern table
T4 Recognition result retaining table
T5 Output data retaining table
T6 Output rule table
11 Document analysis processor
12 Special day expression extracting unit
13 Date expression extracting unit
14 matching processor
15 Date estimation processor
16 Registration processor
17 Output processor

1. An information processing method for registering a special day,
wherein an expression pattern table and a special day data table are registered in a memory of a computer including a function of transmitting and receiving document data,
wherein a plurality of expression patterns are stored in the expression pattern table,
wherein the expression pattern expresses a periodical special day using a first character variable expressing a name of the special day and a second character variable expressing a day,
wherein a plurality of generic names of the special day are stored in the special day data table,
the method comprising:
a first step of performing a morpheme analysis and a syntax analysis to the document data transmitted or received by the computer;
a second step of performing a first search and a second search to the document data based on analysis results of the first step, the first search extracting a character string including the generic name stored in the special day data table and a phrase modifying the generic name, the second search extracting a character string expressing the day;
a third step of performing matching to a range including the character strings extracted from the document data by the first and second searches using the expression pattern table in which the character string extracted by the first search is applied to the first character variable while the character string extracted by second search is applied to the second character variable;
a fourth step of estimating a date of the special day based on concepts of the character strings applied to the first and second character variables, when an expression applied to one of the expression patterns is extracted from the document data through the matching performed in the third step; and
a fifth step of setting the character string applied to the first character variable to the name of the special day, and registering a combination of the name of the special day and the date estimated in the fourth step in the memory of the computer.

2. The information processing method for registering the special day according to claim 1,
wherein, in the third step, when a character string indicating the number of days relative to a present time is extracted as the character string expressing the day by the second search, the date corresponding to the second variable is estimated by applying the number of days relative to the present time, which is indicated by the character string, to a transmission date or a receipt date of the document data as a processing target.

3. The information processing method for registering the special day according to claim 1,
wherein the special day data table includes data in which the generic name of the special day and a replacing generic name are combined,
wherein, in the fifth step when a character string including the generic name combined with the replacing generic name is extracted by the first search, the generic name in the character string applied to the first character variable is changed to the replacing generic name, and
wherein the post-change character string is combined as the name of the special day with the date estimated in the fourth step.

4. The information processing method for registering the special day according to claim 1,
wherein an expression pattern indicating an expression that negates the special day and an expression pattern indicating an expression that affirms the special day are stored in the expression pattern table, and
wherein the fourth step and the fifth step are not performed when an expression applied to the expression pattern indicating the expression that negates the special day is found in the third step.

5. An information processing program for registering a special days stored on a non-transitory computer readable medium,
wherein the program is introduced to a computer including communication section for transmitting and receiving document data,
the program causing the computer to act as:
a storage section in which an expression pattern table and a special day data table are registered, a plurality of expression patterns being stored in the expression pattern table, the expression pattern expressing a periodical special day using a first character variable expressing a name of the special day and a second character variable expressing a day, a plurality of generic names of the special day being stored in the special day data table;
an analysis section that performs a morpheme analysis and a syntax analysis to the document data transmitted or received by the communication section;
a search section that performs a first search and a second search to the document data based on analysis results of the analysis section, the first search extracting a character string including the generic name stored in the special day data table and a phrase modifying the generic name, the second search extracting a character string expressing the day;
an expression matching section that performs matching to a range including the character strings extracted from the document data by the first and second searches using the expression pattern table in which the character string extracted by the first search is applied to the first character variable while the character string extracted by second search is applied to the second character variable;
a date estimation section that estimates a date of the special day based on concepts of the character strings applied to the first and second character variables, when an expression applied to one of the expression patterns is extracted from the document data through the processing of the expression matching section; and
a registration processing section that sets the character string applied to the first character variable to the name of the special day, and registering a combination of the name of the special day and the date estimated by the date estimation section in a memory of the computer.

6. An information processing apparatus comprising:
a storage section in which an expression pattern table and a special day data table are registered, a plurality of expression patterns being stored in the expression pattern table, the expression pattern expressing a periodical special day using a first character variable expressing a name of the special day and a second character variable expressing a day, a plurality of generic names of the special day being stored in the special day data table;
a communication section that transmits and receives document data;
an analysis section that performs a morpheme analysis and a syntax analysis to the document data transmitted or received by the communication section;
a search section that performs a first search and a second search to the document data based on analysis results of the analysis section, the first search extracting a character string including the generic name stored in the special day data table and a phrase modifying the generic name, the second search extracting a character string expressing the day;
an expression matching section that performs matching to a range including the character strings extracted from the document data by the first and second searches using the expression pattern table in which the character string extracted by the first search is applied to the first character variable while the character string extracted by second search is applied to the second character variable;
a date estimation section that estimates a date of the special day based on concepts of the character strings applied to the first and second character variables, when an expression applied to one of the expression patterns is extracted from the document data through the processing of the expression matching section; and
a registration processing section that sets the character string applied to the first character variable to the name of the special day, and registering a combination of the name of the special day and the date estimated by the date estimation section in a memory of the computer.
